(19) United States
(12) Patent Application Publication
(10) Pub. No.: US 2023/0247995 A1
(43) Pub. Date: Aug. 10, 2023

(54) FUNGICIDAL COMBINATIONS

(71) Applicants: UPL Corporation Limited, Port Louis (MU); UPL Europe LTD, Warrington (GB)

(72) Inventors: Dunk Porterfield, Chapel Hill, NC (US); Karen Westcott, Hockessin, DE (US)

(21) Appl. No.: 18/164,064

(22) Filed: Feb. 3, 2023

Related U.S. Application Data
(60) Provisional application No. 63/306,638, filed on Feb. 4, 2022.

(51) Int. Cl. A01N 43/54; A01N 43/42; A01N 25/02; A01P 3/00

(52) U.S. Cl. CPC A01N 43/54; A01N 43/42; A01N 25/02; A01P 3/00

(57) ABSTRACT

Described herein is a fungicidal combination comprising at least one quinoline fungicide and at least one anilinopyrimidine fungicide. The present disclosure also relates to a fungicidal composition comprising the fungicidal combination and at least one agrochemically acceptable excipient. Additionally, the present disclosure relates to a method for controlling growth of fungal disease in a plant, the method comprising applying a fungicidal composition comprising the fungicidal combination to the plant, or a locus, or a plant propagation material thereof.

### CROSS-REFERENCE TO RELATED APPLICATIONS

This application claims priority to U.S. Provisional Application 63/306,638 filed on Feb. 4, 2022, which is incorporated herein by reference in its entirety.

### FIELD OF THE DISCLOSURE

The present disclosure relates to fungicidal combinations for controlling fungal diseases. The present disclosure also relates to fungicidal compositions comprising the fungicidal combinations, and to a method for controlling fungal diseases by applying the fungicidal compositions.

### BACKGROUND

Fungicides are a type of pesticide used for controlling the growth of unwanted fungi and their spores. Profitable crop production depends on effective pest control. Fungicides are an integral and important tool used by farmers to achieve effective control of fungi in order to increase the yield and quality of crops. The activity of fungicides can be enhanced in various ways to achieve maximum benefit. One method for improving fungicidal activity is to use a combination of fungicides. However, the effectiveness of a given combination varies depending on the type of fungus (pest) to be controlled and the type of plant affected by the pest. For example, different pests affect different crops and respond to different fungicides to varying extents. Also crop sensitivity varies based on the type of fungicides being used. As a result, it is challenging to identify an appropriate fungicidal combination, the application rate of the fungicidal composition comprising the fungicidal combination, and the ratio of each fungicide in the combinations that is needed to achieve efficacious control of fungal diseases and increase the yield and quality of crops.

There are a variety of different types of fungicides, including multi-site fungicides and systemic fungicides. However, as crop tolerance decreases, lower use rates are imposed, and fungal resistance is increasingly observed. There is also a need for alternative treatments having broader disease control, curative and preventive functions, and a lower dosage requirement. It is, therefore, necessary to use fungicidal combinations which are capable of overcoming one or more of the aforementioned problems.

### SUMMARY

It is a primary objective of the present disclosure to provide fungicidal combinations comprising at least one quinoline fungicide and at least one anilinopyrimidine fungicide.

It is yet another objective of the present disclosure to provide a fungicidal composition comprising at least one quinoline fungicide, at least one anilinopyrimidine fungicide, and at least one agrochemically acceptable excipient.

It is another objective of the present disclosure to provide a method for controlling fungal growth, said method comprising applying a fungicidal combination to said plants.

It is yet another objective of the present disclosure to provide fungicidal combinations possessing enhanced efficacy compared to the individual fungicides.

It is another objective of the present disclosure to provide fungicidal combinations achieving increased yield in the crops to which they are applied.

It is yet another objective of the present disclosure to provide fungicidal combinations reducing the incidence of fungal diseases in the crops to which they are applied.

In one aspect, the disclosure provides a fungicidal combination comprising (a) at least one quinoline fungicide; and (b) at least one anilinopyrimidine fungicide.

In another aspect, the present disclosure provides a fungicidal composition comprising (a) at least one quinoline fungicide; (b) at least one anilinopyrimidine fungicide; and (c) at least one agrochemically acceptable excipient.

In another aspect, the present disclosure provides use of a fungicidal combination comprising at least one quinoline fungicide and at least one anilinopyrimidine fungicide for controlling growth of fungal disease in plants.

In yet another aspect, the present disclosure provides a method for controlling fungal diseases in a plant, said method comprising applying to the plant, a locus, or a plant propagation material an effective amount of a fungicidal combination comprising at least one quinoline fungicide and at least one anilinopyrimidine fungicide.

Additional features and advantages of the present disclosure will be apparent from the detailed description that follows, which illustrates by way of example, the most preferred features of the present disclosure which are not to be construed as limiting the scope of the disclosure described herein.

### DETAILED DESCRIPTION

The present disclosure now will be described hereinafter with reference to the accompanying examples, in which embodiments of the disclosure are shown. This description is not intended to be a detailed catalogue of all the different ways in which the disclosure may be implemented, or all the features that may be added to the instant disclosure. For example, features illustrated with respect to one embodiment may be incorporated into other embodiments, and features illustrated with respect to a particular embodiment may be deleted from that embodiment. Thus, the disclosure contemplates that in some embodiments of the disclosure, any feature or combination of features set forth herein can be excluded or omitted. In addition, numerous variations and additions to the various embodiments suggested herein will be apparent to those skilled in the art in light of the instant disclosure, which do not depart from the instant disclosure. Hence, the following descriptions are intended to illustrate some particular embodiments of the disclosure, and not to exhaustively specify all permutations, combinations and variations thereof.

Unless otherwise defined, all technical and scientific terms used herein have the same meaning as commonly understood by one of ordinary skill in the art to which this disclosure belongs. Although methods and materials similar or equivalent to those described herein can be used in the practice or testing of the disclosure, suitable methods and materials are described herein.

It must be noted that, as used in this specification, the singular forms “a,” “an” and “the” include plural referents unless the content clearly dictates otherwise. The terms first, second etc., as used herein are not meant to denote any particular ordering, but simply for convenience to denote a plurality of, for example, layers. The terms “preferred” and “preferably” refer to embodiments of the disclosure that may afford certain benefits, under certain circumstances.

As used herein, the terms “comprising” “including,” “having,” “containing,” “involving,” and the like are to be understood to be open-ended, i.e., to mean including but not limited to.

As used herein, the term “about” or “approximately” is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±10% or ±5% of the stated value.

Recitation of ranges of values are merely intended to serve as a shorthand method of referring individually to each separate value falling within the range, unless otherwise indicated herein, and each separate value is incorporated into the specification as if it were individually recited herein. The endpoints of all ranges are included within the range and independently combinable. As used herein, all numerical values or numerical ranges include integers within such ranges and fractions of the values or the integers within ranges unless the context clearly indicates otherwise. Thus, for example, reference to a range of 90-100%, includes 91%, 92%, 93%, 94%, 95%, 95%, 97%, etc., as well as 91.1%, 91.2%, 91.3%, 91.4%, 91.5%, etc., 92.1%, 92.2%, 92.3%, 92.4%, 92.5%, etc., and so forth. All methods described herein can be performed in a suitable order unless otherwise indicated herein or otherwise clearly contradicted by context.

The use of any and all examples, or exemplary language (e.g., “such as”), is intended merely to better illustrate the disclosure and does not pose a limitation on the scope of the disclosure unless otherwise claimed. No language in the specification should be construed as indicating any non-claimed element as essential to the practice of the disclosure as used herein.

While the disclosure has been described with reference to an exemplary embodiment, it will be understood by those skilled in the art that various changes may be made, and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure is not limited to the particular embodiment disclosed as the best mode contemplated for carrying out this disclosure, but that the disclosure will include all embodiments falling within the scope of the appended claims.

As used herein, the expression of various quantities in terms of “%” or “% w/v” or “% w/w” means the percentage by weight of the total solution or composition unless otherwise specified.

As used herein, the term “agrochemical” used herein is understood to denote an agricultural chemical such as pesticides, fungicides, insecticides, acaricides, herbicides, nematicides, plant growth regulators and can be used interchangeably.

As used herein, the term “agrochemically acceptable salt” means a salt which is acceptable for use in agrochemical or horticultural use. The salts referred to herein are agrochemically acceptable salts.

As used herein, the term “agrochemical combination” refers to a mixture of more than one component mixed and intended to be applied onto plants with and without further dilution.

As used herein, the term “fungicide” denotes a compound which controls or modifies the growth of fungus.

As used herein, the term “fungicidal” refers to the ability of a substance to control or modify the growth of fungus.

As used herein, the term “fungicidally effective amount” indicates the quantity of such a compound or combination of such compounds which is capable of controlling or modifying the growth of the fungus. The terms “effective amount” or “agriculturally acceptable effective amount”, refer to an amount of an active ingredient, such as in the disclosed combination(s), which has an adverse effect on a fungus, treats or prevents a fungal disease in a plant, and is not significantly toxic to the plant being treated. The adverse effect can include killing of the fungus (fungicidal), preventing growth of the fungus, blocking of biosynthetic pathway(s), or a combination thereof.

As used herein, the term “control” or “disease control” refers to the treatment and/or prevention of a disease, and specifically, a fungal disease. Controlling effects include any and all deviations from the natural development of the disease, for example, killing of the fungal agent, retardation of disease development, and decrease in amount or degree of the fungal disease.

As used herein, the term “plant(s)” or “crop(s)” refers to all of the physical parts of a plant, including for example, seeds, seedlings, saplings, roots, tubers, stems, stalks, foliage, and fruits. This term also encompasses plant crops such as fruits. The term “plant” may further include the propagation material thereof, which may include all the generative parts of the plant such as seeds and vegetative plant material such as cuttings and tubers, which can be used for the multiplication of the plant. This includes seeds, tubers, spores, corms, bulbs, rhizomes, sprouts basal shoots, stolons, and buds and other parts of plants, including seedlings and young plants, which are to be transplanted after germination or after emergence from soil.

As used herein, the term “locus” refers to the vicinity, area, or place in which the plants are growing, where plant propagation materials of the plants are sown, and/or where the plant propagation materials of the plants will be placed into the soil.

As used herein, the term “plant propagation material” is understood to refer to all of the generative parts of a plant, such as seeds, vegetative material such as cuttings or tubers, roots, fruits, tubers, bulbs, rhizomes, and other parts of plants, germinated plants, and/or young plants which are to be transplanted after germination or after emergence from the soil. These young plants may be protected prior to transplantation by a total or partial immersion treatment/system.

As used herein, the term “seed” embraces seeds and plant propagules of all kinds including but not limited to true seeds, seed pieces, suckers, corms, bulbs, fruit, tubers, grains, cuttings, cut shoots and the like. In a preferred embodiment a seed is a true seed.

As used herein, the term “increased yield” of an agricultural plant means that the yield of a product of the respective plant is increased by a measurable amount over the yield of the same product of the plant produced under the same conditions, but without the application of the compositions described herein. According to the present disclosure, it is preferred that the crop yield be increased by at least 0.5%, preferably at least 2%, more preferably at least 5%, upon application of the combinations and compositions described herein. The composition also increases the vigour/yield of the plant.

As used herein, the term ‘pre-emergence’ refers to the time point before plants emerge from the ground. As used herein, the term ‘post-emergence’ refers to the time point after plants emerge from the ground.

As used herein, the term “g a.i./L” as used herein denotes the concentration of the respective active ingredient in “grams” present “per litre” of the composition.

As used herein, the term “g a.i./h” as used herein denotes the concentration of the respective active ingredient in “grams” applied “per hectare” of the crop field.

As used herein, the term “alkyl” means a straight or branched chain, saturated, monovalent hydrocarbon group including, for example, 1 to 50 carbon atoms (C1 to C50 alkyl).

As used herein, the term “alkylaryl” means an alkyl group covalently linked to a substituted or unsubstituted aryl group that is linked to a compound.

As used herein, the term “aryl,” means a cyclic moiety in which all ring members are carbon and at least one ring is aromatic, the moiety having the specified number of carbon atoms, specifically 6 to 24 carbon atoms, more specifically 6 to 12 carbon atoms. More than one ring may be present, and any additional rings may be independently aromatic, saturated or partially unsaturated, and may be fused, pendant, spirocyclic or a combination thereof.

In another embodiment, individual quinoline fungicides act by different mechanisms such as by affecting plant growth due to antioxidant properties, by being protective and curative, by translocation and inhibition of appressoria development to stop infections, and/or by other unknown mechanisms. The biological mode of action includes inhibition of methionine biosynthesis. Quinoline fungicides comprise ethoxyquin, halacrinate, 8-hydroxyquinoline sulfate, ipflufenoquin, quinacetol and salts of quinacetol, for example quinacetol sulfate, quinofumelin, quinoxyfen, proquinazid, tebufloquin, and combinations thereof. Ethoxyquin has the IUPAC name 1,2-dihydro-2,2,4-trimethyl-6-quinolyl ethyl ether. Halacrinate has the IUPAC name 7-bromo-5-chloro-8-quinolyl acrylate. Ipflufenoquin has the IUPAC name 2-{2-[(7,8-difluoro-2-methyl-3-quinolyl)oxy]-6-fluorophenyl}propan-2-ol. Quinacetol has the IUPAC name 5-acetylquinolin-8-ol. Quinacetol sulfate has IUPAC name sulfuric acid-5-acetylquinolin-8-ol (1/2). Quinofumelin has the IUPAC name 3-(4,4-difluoro-3,4-dihydro-3,3-dimethyl-1-isoquinolyl)Quinoline. Quinoxyfen has the IUPAC name 5,7-dichloro-4-quinolyl 4-fluorophenyl ether. Proquinazid has the IUPAC name 6-iodo-2-propoxy-3-propylquinazolin-4(3H)-one. Tebufloquin has the IUPAC name 6-tert-butyl-8-fluoro-2,3-dimethyl-4-quinolyl acetate.

In another embodiment, anilinopyrimidine fungicide(s) are highly active against a broad range of fungi. The biological mode of action includes inhibition of methionine biosynthesis and secretion of hydrolytic enzymes. Anilinopyrimidine fungicides comprise pyrimethanil, cyprodinil, mepanipyrim, and combinations thereof. Pyrimethanil is a broad spectrum, aminopyrimidine fungicide having the IUPAC name N-(4,6-dimethylpyrimidin-2-yl) aniline. Pyrimethanil has protective action with some curative properties. Pyrimethanil inhibits methionine biosynthesis and thus has a direct effect on protein formation. Cyprodinil has IUPAC name 4-cyclopropyl-6-methyl-N-phenylpyrimidin-2-amine. Mepanipyrim has IUPAC name N-(4-Methyl-6-prop-1-ynylpyrimidin-2-yl)aniline.

In another embodiment, it has been found that the combination of a quinoline fungicide and an anilinopyrimidine fungicide improves effectiveness compared to the effectiveness of the individual fungicides against fungal pests affecting a crop. There was a clear decrease in percentage incidence and percentage severity of fungal disease affecting the crop. The advantages of the disclosed combination were not observed when either the quinoline fungicide or the anilinopyrimidine fungicide was used alone. Therefore, the unexpected advantages of the present disclosure were attributed to the combination of the quinoline fungicide and the anilinopyrimidine fungicide.

In an embodiment, the present disclosure provides an agrochemical combination.

Accordingly in an embodiment, the present disclosure provides a fungicidal combination.

Accordingly in an embodiment, the present disclosure provides fungicidal combinations.

Accordingly in an embodiment, the present disclosure provides a fungicidal combination comprising:

(a) at least one quinoline fungicide; and

(b) at least one anilinopyrimidine fungicide.

As used throughout the disclosure, the quinoline fungicide or other active ingredients for example, the anilinopyrimidine fungicide, include their salts, esters, ethers, polymorphs including solvates and hydrates. A salt includes salts that retain the biological effectiveness and properties of the active ingredient, and which are not biologically or otherwise undesirable, and include derivatives of the disclosed compounds in which the parent compound is modified by making inorganic and organic, non-toxic, acid or base addition salts thereof. The salts can be synthesized from the parent compound by conventional chemical methods.

According to an embodiment, the quinoline fungicide comprises ethoxyquin, halacrinate, 8-hydroxyquinoline sulfate, ipflufenoquin, quinacetol and salts of quinacetol, for example quinacetol sulfate, quinofumelin, quinoxyfen, proquinazid, tebufloquin, or a combination thereof.

In a preferred embodiment, the quinoline fungicide is ipflufenoquin.

According to an embodiment, the anilinopyrimidine fungicide comprises pyrimethanil, cyprodinil, mepanipyrim, or a combination thereof.

In a preferred embodiment, the anilinopyrimidine fungicide is pyrimethanil.

In a preferred embodiment, the anilinopyrimidine fungicide is cyprodinil.

In an embodiment, the present disclosure provides a fungicidal combination comprising:

(a) at least one quinoline fungicide; and

(b) at least one anilinopyrimidine fungicide;

wherein the quinoline fungicide is ipflufenoquin.

In an embodiment, the present disclosure provides a fungicidal combination comprising:

(a) ipflufenoquin; and

(b) at least one anilinopyrimidine fungicide.

In an embodiment, the present disclosure provides a fungicidal combination comprising:

(a) at least one quinoline fungicide; and

(b) at least one anilinopyrimidine fungicide;

wherein the anilinopyrimidine fungicide is pyrimethanil.

In an embodiment, the present disclosure provides a fungicidal combination comprising:

(a) at least one quinoline fungicide; and

(b) pyrimethanil.

In an embodiment, the present disclosure provides a fungicidal combination comprising:

(a) ipflufenoquin; and

(b) pyrimethanil.

In an embodiment, the present disclosure provides a fungicidal combination comprising:

(a) at least one quinoline fungicide; and

(b) at least one anilinopyrimidine fungicide;

wherein the anilinopyrimidine fungicide is cyprodinil.

In an embodiment, the present disclosure provides a fungicidal combination comprising:

(a) at least one quinoline fungicide; and

(b) cyprodinil.

In an embodiment, the present disclosure provides a fungicidal combination comprising:

(a) ipflufenoquin; and

(b) cyprodinil.

In an embodiment, the present disclosure provides a fungicidal combination comprising:

(a) ethoxyquin; and

(b) pyrimethanil.

In an embodiment, the present disclosure provides a fungicidal combination comprising:

(a) halacrinate; and

(b) pyrimethanil.

In an embodiment, the present disclosure provides a fungicidal combination comprising:

(a) 8-hydroxyquinoline sulfate; and

(b) pyrimethanil.

In an embodiment, the present disclosure provides a fungicidal combination comprising:

(a) quinacetol; and

(b) pyrimethanil.

In an embodiment, the present disclosure provides a fungicidal combination comprising:

(a) quinacetol sulfate; and

(b) pyrimethanil.

In an embodiment, the present disclosure provides a fungicidal combination comprising:

(a) quinofumelin; and

(b) pyrimethanil.

In an embodiment, the present disclosure provides a fungicidal combination comprising:

(a) quinoxyfen; and

(b) pyrimethanil.

In an embodiment, the present disclosure provides a fungicidal combination comprising:

(a) proquinazid; and

(b) pyrimethanil.

In an embodiment, the present disclosure provides a fungicidal combination comprising:

(a) tebufloquin; and

(b) pyrimethanil.

According to an embodiment, the fungicidal combination comprises quinoline fungicide in a concentration range from about 1 to about 300 g/L.

In a preferred embodiment, the fungicidal combination comprises quinoline fungicide in a concentration range from about 1 to about 200 g/L.

In a preferred embodiment, the fungicidal combination comprises quinoline fungicide in a concentration range from about 10 to about 150 g/L.

In a preferred embodiment, the fungicidal combination comprises quinoline fungicide in a concentration range from about 10 to about 100 g/L.

In a preferred embodiment, the fungicidal combination comprises ipflufenoquin in a concentration range from about 10 to about 100 g/L.

In a preferred embodiment, the fungicidal combination comprises ipflufenoquin in a concentration range of about 78.65 g/L.

In a preferred embodiment, the fungicidal combination comprises ipflufenoquin in a concentration range of about 69.70 g/L.

According to an embodiment, the fungicidal combination comprises anilinopyrimidine fungicide in a concentration range from about 100 to about 700 g/L.

In a preferred embodiment, the fungicidal combination comprises anilinopyrimidine fungicide in a concentration range from about 150 to about 650 g/L.

In a preferred embodiment, the fungicidal combination comprises anilinopyrimidine fungicide in a concentration range from about 200 to about 600 g/L.

In a preferred embodiment, the fungicidal combination comprises anilinopyrimidine fungicide in a concentration range from about 250 to about 550 g/L.

In a preferred embodiment, the fungicidal combination comprises pyrimethanil in a concentration range from about 250 to about 550 g/L.

In a preferred embodiment, the fungicidal combination comprises pyrimethanil in a concentration range of about 532.62 g/L.

In a preferred embodiment, the fungicidal combination comprises cyprodinil in a concentration range from about 250 to about 550 g/L.

In a preferred embodiment, the fungicidal combination comprises cyprodinil in a concentration range of about 348.40 g/L.

According to an embodiment, the weight ratio of the quinoline fungicide to the anilinopyrimidine fungicide is from about 100:1 to about 1:100.

In a preferred embodiment, the weight ratio of the quinoline fungicide to the anilinopyrimidine fungicide is selected from ratios comprising 1:1, 10:1, 20:1, 30:1, 40:1, 50:1, 60:1, 70:1, 80:1, 90:1 and 100:1.

In a preferred embodiment, the weight ratio of the quinoline fungicide to the anilinopyrimidine fungicide is selected from ratios comprising 1:1, 1:10, 1:20, 1:30, 1:40, 1:50, 1:60, 1:70, 1:80, 1:90 and 1:100.

In a preferred embodiment, the weight ratio of the quinoline fungicide to the anilinopyrimidine fungicide is from about 50:1 to about 1:50.

In a preferred embodiment, the weight ratio of the quinoline fungicide to the anilinopyrimidine fungicide is from about 25:1 to about 1:25.

In a preferred embodiment, the weight ratio of the quinoline fungicide to the anilinopyrimidine fungicide is from about 20:1 to about 1:20.

In a preferred embodiment, the weight ratio of the quinoline fungicide to the anilinopyrimidine fungicide is from about 10:1 to about 1:10.

In a preferred embodiment, the weight ratio of the quinoline fungicide to the anilinopyrimidine fungicide is from about 1:4 to about 1:8, or about 1:4 to 1:7, or about 1:4.5 to 1:7.

In a preferred embodiment, the weight ratio of the quinoline fungicide to the anilinopyrimidine fungicide is about 1:6.7.

In a preferred embodiment, the weight ratio of ipflufenoquin to pyrimethanil is about 1:6.7.

In a preferred embodiment, the weight ratio of the quinoline fungicide to the anilinopyrimidine fungicide is about 1:4.9.

In a preferred embodiment, the weight ratio of ipflufenoquin to cyprodinil is about 1:4.9.

Accordingly in an embodiment, the present disclosure provides an agrochemical composition.

Accordingly in an embodiment, the present disclosure provides a fungicidal composition.

Accordingly in an embodiment, the present disclosure provides fungicidal compositions.

Accordingly in an embodiment, the present disclosure provides a fungicidal composition comprising:

(a) at least one quinoline fungicide;

(b) at least one anilinopyrimidine fungicide; and

(c) at least one agrochemically acceptable excipient.

In an embodiment, the quinolone fungicide comprises ethoxyquin, halacrinate, 8-hydroxyquinoline sulfate, ipflufenoquin, quinacetol and salts thereof, for example quinacetol sulfate, quinofumelin, quinoxyfen, proquinazid, tebufloquin, or a combination thereof.

In a preferred embodiment, the quinoline fungicide is ipflufenoquin.

In an embodiment, the anilinopyrimidine fungicide comprises pyrimethanil, cyprodinil, mepanipyrim, or a combination thereof.

In a preferred embodiment, the anilinopyrimidine fungicide is pyrimethanil.

In a preferred embodiment, the anilinopyrimidine fungicide is cyprodinil.

According to an embodiment, the present disclosure provides a fungicidal composition comprising:

(a) at least one quinoline fungicide;

(b) at least one anilinopyrimidine fungicide; and

(c) at least one agrochemically acceptable excipient;

wherein the quinoline fungicide is ipflufenoquin.

In a preferred embodiment, the present disclosure provides a fungicidal composition comprising:

(a) ipflufenoquin;

(b) at least one anilinopyrimidine fungicide; and

(c) at least one agrochemically acceptable excipient.

According to an embodiment, the present disclosure provides a fungicidal composition comprising:

(a) at least one quinoline fungicide;

(b) at least one anilinopyrimidine fungicide; and

(c) at least one agrochemically acceptable excipient;

wherein the anilinopyrimidine fungicide is pyrimethanil.

In a preferred embodiment, the present disclosure provides a fungicidal composition comprising:

(a) at least one quinoline fungicide;

(b) pyrimethanil; and

(c) at least one agrochemically acceptable excipient.

In a preferred embodiment, the present disclosure provides a fungicidal composition comprising:

(a) ipflufenoquin;

(b) pyrimethanil; and

(c) at least one agrochemically acceptable excipient.

According to an embodiment, the present disclosure provides a fungicidal composition comprising:

(a) at least one quinoline fungicide;

(b) at least one anilinopyrimidine fungicide; and

(c) at least one agrochemically acceptable excipient;

wherein the anilinopyrimidine fungicide is cyprodinil.

In a preferred embodiment, the present disclosure provides a fungicidal composition comprising:

(a) at least one quinoline fungicide;

(b) cyprodinil; and

(c) at least one agrochemically acceptable excipient.

In a preferred embodiment, the present disclosure provides a fungicidal composition comprising:

(a) ipflufenoquin;

(b) cyprodinil; and

(c) at least one agrochemically acceptable excipient.

In an embodiment, the agrochemically acceptable excipient comprises one or more of dispersant/dispersing agents, carriers, emulsifiers, colorants, thickeners/binders, antifreeze agents, antifoaming agents, antioxidants, solvents, preservatives, diluents, other auxiliary agents, or combinations thereof.

In another embodiment, the dispersant/dispersing agents include anionic surfactants such as alkyl sulfate ester salts, alkylaryl sulfonate salts, dialkyl sulfosuccinate salts, polyoxyethylene alkylaryl ether phosphate ester salts, lignosulfonate salts and naphthalene sulfonate formaldehyde polycondensates, sodium salt of naphthalene sulfonate condensate; and nonionic surfactants such as polyoxyethylene alkyl aryl ethers, polyoxyethylene alkylpolyoxypropylene block copolymers and sorbitan fatty acid esters and cationic surfactants such as alkyltrimethylammonium salts. Other examples include acrylic copolymer solution, polyalkylene oxide block copolymer and combinations thereof.

In another embodiment, the carrier may include minerals such as kaolin clay, attapulgite clay, bentonite, montmorillonite, acid white clay, pyrophyllite, talc, diatomaceous earth and calcite; natural organic materials such as corn rachis powder and walnut husk powder; synthetic organic materials such as urea; salts such as calcium carbonate and ammonium sulfate; synthetic inorganic materials such as synthetic hydrated silicon oxide. Examples of the liquid carrier include aromatic hydrocarbons such as xylene, alkylbenzene and methylnaphthalene; alcohols such as 2-propanol, ethylene glycol, propylene glycol, and ethylene glycol monoethyl ether; ketones such as acetone, cyclohexanone and isophorone; vegetable oil such as soybean oil and cotton seed oil; petroleum aliphatic hydrocarbons, esters, dimethylsulfoxide, acetonitrile and water.

In another embodiment, emulsifiers which can be advantageously employed herein can be readily determined by those skilled in the art and include various non-ionic, anionic, cationic, and amphoteric emulsifiers, or a blend of two or more emulsifiers. Examples of non-ionic emulsifiers useful in preparing emulsifiable concentrates, for example, include the polyalkylene glycol ethers and condensation products of alkyl and aryl phenols, aliphatic alcohols, aliphatic amines or fatty acids with ethylene oxide, propylene oxides such as the ethoxylated alkyl phenols and carboxylic esters solubilized with the polyol or polyoxyalkylene. Cationic emulsifiers include quaternary ammonium compounds and fatty amine salts. Anionic emulsifiers include the oil-soluble salts (e.g., calcium) of alkylaryl sulfonic acids, oil-soluble salts or sulfated polyglycol ethers and appropriate salts of phosphated polyglycol ether. Other examples include tristyrylphenol ethoxylate, linear calcium alkylbenzene sulphonate, castor oil ethoxylate, and combinations thereof.

In an embodiment, colorants may comprise iron oxide, titanium oxide and Prussian Blue, and organic dyestuffs, such as alizarin dyestuffs, azo dyestuffs or metal phthalocyanine dyestuffs, and trace elements, such as salts of iron, manganese, boron, copper, cobalt, molybdenum and zinc.

In an embodiment, thickeners/binders/gelling agents may comprise, but are not limited to, molasses, granulated sugar, alginates, karaya gum, jaguar gum, tragacanth gum, polysaccharide gum, mucilage, xanthan gum or combination thereof. In another embodiment, the binder may be selected from silicates such as magnesium aluminium silicate, polyvinyl acetates, polyvinyl acetate copolymers, polyvinyl alcohols, polyvinyl alcohol copolymers, celluloses, including ethylcelluloses and methylcelluloses, hydroxymethyl celluloses, hydroxypropylcelluloses, hydroxymethylpropyl-celluloses, polyvinylpyrolidones, dextrins, malto-dextrins, polysaccharides, fats, oils, proteins, gum arabics, shellacs, vinylidene chloride, vinylidene chloride copolymers, calcium lignosulfonates, acrylic copolymers, starches, polyvinylacrylates, zeins, gelatin, carboxymethylcellulose, chitosan, polyethylene oxide, acrylimide polymers and copolymers, polyhydroxyethyl acrylate, methylacrylimide monomers, alginate, ethylcellulose, polychloroprene and syrups or mixtures thereof; polymers and copolymers of vinyl acetate, methyl cellulose, vinylidene chloride, acrylic, cellulose, polyvinylpyrrolidone and polysaccharide; polymers and copolymers of vinylidene chloride and vinyl acetate-ethylene copolymers; combinations of polyvinyl alcohol and sucrose; plasticizers such as glycerol, propylene glycol, polyglycols.

In another embodiment, antifreeze agent(s) added to the composition may be alcohols such as ethylene glycol, propylene glycol, 1,2-propylene glycol, 1,3-propylene glycol, 1,2-propanediol, 1,2-butanediol, 1,3-butanediol, 1,4-butanediol, 1,4-pentanediol, 3-methyl-L5-pentanediol, 2,3-dimethyl-2,3-butanediol, trimethylol propane, mannitol, sorbitol, glycerol, pentaerythritol, 1,4-cyclohexanedimethanol, xylenol, bisphenols such as bisphenol A or the like. In addition, ether alcohols such as diethylene glycol, triethylene glycol, tetraethylene glycol, polyoxyethylene or polyoxypropylene glycols of molecular weight up to about 4000, diethylene glycol monomethyl ether, diethylene glycol monoethyl ether, triethylene glycol monomethyl ether, butoxyethanol, butylene glycol monobutyl ether, dipentaerythritol, tripentaerythritol, tetrapentaerythritol, diglycerol, triglycerol, tetraglycerol, pentaglycerol, hexaglycerol, heptaglycerol, octaglycerol.

According to an embodiment, an antifoam agent may comprise polydimethoxysiloxane, polydimethylsiloxane, dimethylsiloxane polymers, siloxane polyalkyleneoxide copolymer, polypropylene glycol, alkyl poly acrylates, castor oil, fatty acids, fatty acid esters, fatty acid sulfates, fatty alcohols, fatty alcohol esters, fatty alcohol sulfate, olive oil, mono and di glycerides, paraffin oil, paraffin wax, poly propylene glycol, silicone oil, vegetable fats, vegetable fat sulfates, vegetable oil, vegetable oil sulfates, vegetable wax, vegetable wax sulfates, agents based on silicon or magnesium stearate, and combinations thereof.

In another embodiment, antioxidants are, for example, amino acids (e.g., glycine, histidine, tyrosine, tryptophan) and derivatives thereof, imidazole and imidazole derivatives (e.g., urocanic acid), peptides, such as, for example, D,L-carnosine, D-carnosine, L-carnosine and derivatives thereof (e.g., anserine), carotenoids, carotenes (e.g., α-carotene, β-carotene, lycopene) and derivatives thereof, lipoic acid and derivatives thereof (e.g., dihydrolipoic acid), aurothioglucose, propylthiouracil and further thio compounds (e.g., thioglycerol, thiosorbitol, thioglycolic acid, thioredoxin, glutathione, cysteine, cystine, cystamine and the glycosyl, N-acetyl, methyl, ethyl, propyl, amyl, butyl, lauryl, palmitoyl, oleyl, γ-linoleyl, cholesteryl and glyceryl esters thereof), and salts thereof, dilauryl thiodipropionate, distearyl thiodipropionate, thiodipropionic acid and derivatives thereof (esters, ethers, peptides, lipids, nucleotides, nucleosides and salts), and sulfoximine compounds (e.g., buthionine sulfoximines, homocysteine sulfoximine, buthionine sulfones, penta-, hexa-, heptathionine sulfoximine) in very low tolerated doses (e.g., pmol/kg to pmol/kg), also metal chelating agents (e.g., α-hydroxy fatty acids, EDTA, EGTA, phytic acid, lactoferrin), α-hydroxy acids (e.g., citric acid, lactic acid, malic acid), humic acids, bile acid, bile extracts, gallic esters (e.g., propyl, octyl and dodecyl gallate), flavonoids, catechins, bilirubin, biliverdin and derivatives thereof, unsaturated fatty acids and derivatives thereof (e.g., γ-linolenic acid, linoleic acid, arachidonic acid, oleic acid), folic acid and derivatives thereof, hydroquinone and derivatives thereof (e.g., arbutin), ubiquinone and ubiquinol, and derivatives thereof, vitamin C and derivatives thereof (e.g., ascorbyl palmitate, stearate, dipalmitate, acetate, Mg ascorbyl phosphates, sodium and magnesium ascorbate, disodium ascorbyl phosphate and sulfate, potassium ascorbyl tocopheryl phosphate, chitosan ascorbate), isoascorbic acid and derivatives thereof, tocopherols and derivatives thereof (e.g., tocopheryl acetate, linoleate, oleate and succinate, tocophereth-5, tocophereth-10, tocophereth-12, tocophereth-18, tocophereth-50, tocophersolan), vitamin A and derivatives (e.g., vitamin A palmitate), the coniferyl benzoate of benzoin resin, rutin, rutinic acid and derivatives thereof, disodium rutinyl disulfate, cinnamic acid and derivatives thereof (e.g., ferulic acid, ethyl ferulate, caffeic acid), kojic acid, chitosan glycolate and salicylate, butylhydroxytoluene, butylhydroxyanisol, nordihydroguaiacic acid, nordihydroguaiaretic acid, trihydroxybutyrophenone, uric acid and derivatives thereof, mannose and derivatives thereof, selenium and selenium derivatives (e.g., selenomethionine), stilbenes and stilbene derivatives (e.g., stilbene oxide, trans-stilbene oxide). According to the disclosure, derivatives (salts, esters, sugars, nucleotides, nucleosides, peptides, and lipids) and mixtures of these specified active ingredients or plant extracts (e.g., tea tree oil, rosemary extract and rosemarinic acid) which comprise these antioxidants can be used. In general, mixtures of the aforementioned antioxidants are possible.

According to an embodiment, exemplary solvents includewater, oils of vegetable, cyclohexanone, 2-butoxyethanol, and derivatives thereof. In principle, solvent mixtures may also be used.

In another embodiment, exemplary preservatives include benzothiazoles, 1,2-benzisothiazolin-3-one, sodium dichloro-s-triazinetrione, sodium benzoate, potassium sorbate, 1,2-phenyl-isothiazolin-3-one, 2-bromo-2-nitro-1,3-propanediol, inter chloroxylenol paraoxybenzoate butyl and benzoic acid, and combinations thereof.

According to an embodiment, an example of suitable diluent is water.

According to an embodiment, examples of the other auxiliary agents that can be included in the composition include water-soluble polymers such as polyvinyl alcohol and polyvinylpyrrolidone, polysaccharides such as Arabic gum, alginic acid, or a salt thereof, carboxymethylcellulose (CMC), xanthan gum, inorganic materials such as aluminum magnesium silicate and alumina sol, preservatives, coloring agents and stabilization agents such as acid phosphate isopropyl (PAP), and butylated hydroxytoluene (BHT).

Accordingly in an embodiment, the present disclosure provides a fungicidal composition comprising:

(a) at least one quinoline fungicide;

(b) at least one anilinopyrimidine fungicide; and

(c) optionally at least one agrochemically acceptable excipient.

In a preferred embodiment, the fungicidal composition comprises from about 0.1% w/w to about 70% w/w of the quinoline fungicide of the total weight of the composition.

In a preferred embodiment, the fungicidal composition comprises from about 1% w/w to about 60% w/w of the quinoline fungicide of the total weight of the composition.

In a preferred embodiment, the fungicidal composition comprises from about 1% w/w to about 50% w/w of the quinoline fungicide of the total weight of the composition.

In a preferred embodiment, the fungicidal composition comprises from about 1% w/w to about 30% w/w of the quinoline fungicide of the total weight of the composition.

In a preferred embodiment, the fungicidal composition comprises of about 7.15% w/w of the quinoline fungicide of the total weight of the composition.

In a preferred embodiment, the fungicidal composition comprises of about 7.15% w/w of ipflufenoquin of the total weight of the composition.

In a preferred embodiment, the fungicidal composition comprises of about 6.69% w/w of the quinoline fungicide of the total weight of the composition.

In a preferred embodiment, the fungicidal composition comprises of about 6.69% w/w of ipflufenoquin of the total weight of the composition.

According to an embodiment, the fungicidal composition comprises from about 1% w/w to about 70% w/w of the anilinopyrimidine fungicide of the total weight of the composition.

In a preferred embodiment, the fungicidal composition comprises from about 1% w/w to about 60% w/w of the anilinopyrimidine fungicide of the total weight of the composition.

In a preferred embodiment, the fungicidal composition comprises from about 10% w/w to about 50% w/w of the anilinopyrimidine fungicide of the total weight of the composition.

In a preferred embodiment, the fungicidal composition comprises from about 20% w/w to about 50% w/w of the anilinopyrimidine fungicide of the total weight of the composition.

In a preferred embodiment, the fungicidal composition comprises of about 48.42% w/w of the anilinopyrimidine fungicide of the total weight of the composition.

In a preferred embodiment, the fungicidal composition comprises of about 48.42% w/w of pyrimethanil of the total weight of the composition.

In a preferred embodiment, the fungicidal composition comprises of about 34.04% w/w of the anilinopyrimidine fungicide of the total weight of the composition.

In a preferred embodiment, the fungicidal composition comprises of about 34.04% w/w of cyprodinil of the total weight of the composition.

According to an embodiment, the fungicidal composition comprises from about 1% w/w to about 30% w/w of the agriculturally acceptable excipient of the total weight of the composition.

According to an embodiment, the present disclosure provides a fungicidal composition comprising:

(a) from about 1% w/w to about 30% w/w of at least one quinoline fungicide;

(b) from about 20% w/w to about 50% w/w of at least one anilinopyrimidine fungicide; and

(c) from about 1% w/w to about 30% w/w of at least one agrochemically acceptable excipient.

In a preferred embodiment, the present disclosure provides a fungicidal composition comprising:

(a) from about 1% w/w to about 60% w/w of ipflufenoquin;

(b) from about 1% w/w to about 60% w/w of pyrimethanil; and

(c) from about 1% w/w to about 30% w/w of at least one agrochemically acceptable excipient.

In a preferred embodiment, the present disclosure provides a fungicidal composition comprising:

(a) from about 1% w/w to about 60% w/w of ipflufenoquin;

(b) from about 1% w/w to about 60% w/w of cyprodinil; and

(c) from about 1% w/w to about 30% w/w of at least one agrochemically acceptable excipient.

In a preferred embodiment, the present disclosure provides a fungicidal composition comprising:

(a) from about 1% w/w to about 50% w/w of ipflufenoquin;

(b) from about 10% w/w to about 50% w/w of pyrimethanil; and

(c) from about 1% w/w to about 30% w/w of at least one agrochemically acceptable excipient.

In a preferred embodiment, the present disclosure provides a fungicidal composition comprising:

(a) from about 1% w/w to about 50% w/w of ipflufenoquin;

(b) from about 10% w/w to about 50% w/w of cyprodinil; and

(c) from about 1% w/w to about 30% w/w of at least one agrochemically acceptable excipient.

In a preferred embodiment, the present disclosure provides a fungicidal composition comprising:

(a) from about 1% w/w to about 30% w/w of ipflufenoquin;

(b) from about 20% w/w to about 50% w/w of pyrimethanil; and

(c) from about 1% w/w to about 30% w/w of at least one agrochemically acceptable excipient.

In a preferred embodiment, the present disclosure provides a fungicidal composition comprising:

(a) from about 1% w/w to about 30% w/w of ipflufenoquin;

(b) from about 20% w/w to about 50% w/w of cyprodinil; and

(c) from about 1% w/w to about 30% w/w of at least one agrochemically acceptable excipient.

In an embodiment, the compositions of the present disclosure are produced by combining the actives with at least one agrochemically acceptable excipient to prepare a mixture and formulating the mixture into a solid or liquid formulation. Examples of the solid or liquid formulation include, but are not limited to, wettable powders, granules, dusts, soluble (liquid) concentrates, suspension concentrates (SC), oil in water emulsions (EW), water in oil emulsions, emulsifiable concentrates, capsule suspensions, ZC (mixed formulation of capsule suspension and suspension concentrate) formulations, oil dispersions, other known formulation types, and combinations thereof.

According to an embodiment, the present disclosure provides a fungicidal composition comprising:

(a) at least one quinoline fungicide;

(b) at least one anilinopyrimidine fungicide; and

(c) at least one agrochemically acceptable excipient

wherein the fungicidal composition is present in a form of a liquid formulation.

In an embodiment, the liquid formulation is selected from a capsule suspension (CS), a dispersible concentrate (DC), a water in oil emulsion (EO), an oil in water emulsion (EW), an oil dispersion (OD), an oil miscible flowable concentrate (oil miscible suspension (OF)), an oil miscible liquid (OL), a suspension concentrate (SC), a soluble concentrate (SL), or a suspo-emulsion (SE).

In a preferred embodiment, the liquid formulation is an oil in water emulsion (EW).

In a preferred embodiment, the liquid formulation is a suspension concentrate (SC).

According to an embodiment, the present disclosure provides a liquid formulation fungicidal combination comprising:

(a) at least one quinoline fungicide; and

(b) at least one anilinopyrimidine fungicide.

According to an embodiment, the present disclosure provides a liquid formulation fungicidal composition comprising:

(a) at least one quinoline fungicide;

(b) at least one anilinopyrimidine fungicide; and

(c) at least one agrochemically acceptable excipient.

In a preferred embodiment, the present disclosure provides a liquid formulation fungicidal composition comprising:

(a) ipflufenoquin;

(b) pyrimethanil; and

(c) at least one agrochemically acceptable excipient.

In a preferred embodiment, the present disclosure provides a liquid formulation fungicidal composition comprising:

(a) ipflufenoquin;

(b) cyprodinil; and

(c) at least one agrochemically acceptable excipient.

According to an embodiment, the present disclosure provides a suspension concentrate (SC) fungicidal composition comprising:

(a) ipflufenoquin;

(b) pyrimethanil; and

(c) at least one agrochemically acceptable excipient.

According to an embodiment, the present disclosure provides an emulsion oil in water (EW) fungicidal composition comprising:

(a) ipflufenoquin;

(b) cyprodinil; and

(c) at least one agrochemically acceptable excipient.

According to an embodiment, the present disclosure provides a fungicidal composition comprising:

(a) at least one quinoline fungicide;

(b) at least one anilinopyrimidine fungicide; and

(c) at least one agrochemically acceptable excipient

wherein the fungicidal composition is present in a form of a tank mix or a pre-formulated (pre-mix)/ready-mix formulation.

In a preferred embodiment, the present disclosure provides a fungicidal composition comprising:

(a) ipflufenoquin;

(b) pyrimethanil; and

(c) at least one agrochemically acceptable excipient;

wherein the fungicidal composition is present in a form of a tank mix or a pre-formulated (pre-mix)/ready-mix formulation.

In a preferred embodiment, the present disclosure provides a fungicidal composition comprising:

(a) ipflufenoquin;

(b) cyprodinil; and

(c) at least one agrochemically acceptable excipient;

wherein the fungicidal composition is present in a form of a tank mix or a pre-formulated (pre-mix)/ready-mix formulation.

According to an embodiment, the present disclosure provides a fungicidal composition in a form of a tank mix formulation.

In a preferred embodiment, the present disclosure provides a tank mix fungicidal composition comprising:

(a) ipflufenoquin;

(b) pyrimethanil; and

(c) at least one agrochemically acceptable excipient.

In a preferred embodiment, the present disclosure provides a tank mix fungicidal composition comprising:

(a) ipflufenoquin;

(b) cyprodinil; and

(c) at least one agrochemically acceptable excipient.

According to an embodiment, the present disclosure provides a fungicidal composition in a form of a pre-formulated (pre-mix)/ready-mix formulation.

In a preferred embodiment, the present disclosure provides a pre-mix fungicidal composition comprising:

(a) ipflufenoquin;

(b) pyrimethanil; and

(c) at least one agrochemically acceptable excipient.

In a preferred embodiment, the present disclosure provides a pre-mix fungicidal composition comprising:

(a) ipflufenoquin;

(b) cyprodinil; and

(c) at least one agrochemically acceptable excipient.

In another embodiment, the fungicidal combinations disclosed herein may be applied simultaneously as a tank mix or together as a pre-mix formulation, or each fungicide may be applied sequentially.

In yet another embodiment, the fungicidal compositions may be applied to the soil prior to emergence of the plants (pre-emergence), either pre-planting or post-planting. Alternatively, the application of the fungicidal composition may be a post-emergent application (post-emergence).

In yet another embodiment, the fungicidal combination may be applied as a foliar spray at different timings during crop development, with as many early applications (pre-emergence) or late post-emergence.

According to an embodiment, the fungicidal combination or the fungicidal composition further comprises an additional fungicide or an additional insecticide.

According to an embodiment, the present disclosure provides use of a fungicidal combination comprising at least one quinoline fungicide and at least one anilinopyrimidine fungicide for controlling growth of fungal disease in plants.

According to an embodiment, the present disclosure provides use of the fungicidal combination for controlling fungal growth, wherein the fungicidal combination comprises:

(a) at least one quinoline fungicide; and

(b) at least one anilinopyrimidine fungicide.

In another embodiment, the present disclosure provides use of the fungicidal combination for controlling growth of fungal diseases, wherein the fungicidal combination comprises:

(a) at least one quinoline fungicide; and

(b) at least one anilinopyrimidine fungicide.

In a preferred embodiment, the present disclosure provides use of the fungicidal combination for controlling fungal growth, wherein the fungicidal combination comprises:

(a) ipflufenoquin; and

(b) pyrimethanil.

In a preferred embodiment, the present disclosure provides use of the fungicidal combination for controlling growth of fungal diseases, wherein the fungicidal combination comprises:

(a) ipflufenoquin; and

(b) pyrimethanil.

In a preferred embodiment, the present disclosure provides use of the fungicidal combination for controlling fungal growth, wherein the fungicidal combination comprises:

(a) ipflufenoquin; and

(b) cyprodinil.

In a preferred embodiment, the present disclosure provides use of the fungicidal combination for controlling growth of fungal diseases, wherein the fungicidal combination comprises:

(a) ipflufenoquin; and

(b) cyprodinil.

According to an embodiment, the present disclosure provides use of the fungicidal composition for controlling fungal growth, wherein the fungicidal composition comprises:

(a) at least one quinoline fungicide;

(b) at least one anilinopyrimidine fungicide; and

(c) at least one agrochemically acceptable excipient.

According to an embodiment, the present disclosure provides use of the fungicidal composition for controlling growth of fungal diseases, wherein the fungicidal composition comprises:

(a) at least one quinoline fungicide;

(b) at least one anilinopyrimidine fungicide; and

(c) at least one agrochemically acceptable excipient.

In a preferred embodiment, the present disclosure provides use of the fungicidal composition for controlling fungal growth, wherein the fungicidal composition comprises:

(a) ipflufenoquin;

(b) pyrimethanil; and

(c) at least one agrochemically acceptable excipient.

In a preferred embodiment, the present disclosure provides use of the fungicidal composition for controlling growth of fungal diseases, wherein the fungicidal composition comprises:

(a) ipflufenoquin;

(b) pyrimethanil; and

(c) at least one agrochemically acceptable excipient.

In a preferred embodiment, the present disclosure provides use of the fungicidal composition for controlling fungal growth, wherein the fungicidal composition comprises:

(a) ipflufenoquin;

(b) cyprodinil; and

(c) at least one agrochemically acceptable excipient.

In a preferred embodiment, the present disclosure provides use of the fungicidal composition for controlling growth of fungal diseases, wherein the fungicidal composition comprises:

(a) ipflufenoquin;

(b) cyprodinil; and

(c) at least one agrochemically acceptable excipient.

In another embodiment, the fungicidal combinations and/or compositions may be applied before or after infection of the plants or the propagation material thereof, by the fungi.

In another embodiment, the fungicidal combinations and compositions may be used for foliar application, application to a ground, or to a plant or to a locus or to a plant propagation material, or combinations thereof.

According to an embodiment, the present disclosure provides a process for the preparation of the fungicidal combination comprising:

(a) at least one quinoline fungicide; and

(b) at least one anilinopyrimidine fungicide;

wherein the process comprises adding and mixing at least one quinoline fungicide and at least one anilinopyrimidine fungicide, to obtain the fungicidal combination.

In a preferred embodiment, the present disclosure provides a process for the preparation of the fungicidal combination comprising:

(a) ipflufenoquin; and

(b) Pyrimethanil;

wherein the process comprises adding and mixing ipflufenoquin and pyrimethanil, to obtain the fungicidal combination.

In a preferred embodiment, the present disclosure provides a process for the preparation of the fungicidal combination comprising:

(a) ipflufenoquin; and

(b) Cyprodinil;

wherein the process comprises adding and mixing ipflufenoquin and cyprodinil, to obtain the fungicidal combination.

According to an embodiment, the present disclosure provides a process for the preparation of the fungicidal composition comprising:

(a) at least one quinoline fungicide;

(b) at least one anilinopyrimidine fungicide; and

(c) at least one agrochemically acceptable excipient;

wherein the process comprises adding and mixing at least one quinoline fungicide, at least one anilinopyrimidine fungicide and at least one agrochemically acceptable excipient, to obtain the fungicidal composition.

In a preferred embodiment, the present disclosure provides a process for the preparation of the fungicidal composition comprising:

(a) ipflufenoquin;

(b) pyrimethanil; and

(c) at least one agrochemically acceptable excipient;

wherein the process comprises adding and mixing ipflufenoquin, pyrimethanil and at least one agrochemically acceptable excipient, to obtain the fungicidal composition.

In a preferred embodiment, the present disclosure provides a process for the preparation of the fungicidal composition comprising:

(a) ipflufenoquin;

(b) cyprodinil; and

(c) at least one agrochemically acceptable excipient;

wherein the process comprises adding and mixing ipflufenoquin, cyprodinil and at least one agrochemically acceptable excipient, to obtain the fungicidal composition.

According to an embodiment, the process for preparation of the fungicidal combination comprises:

adding and mixing at least one quinoline fungicide and at least one anilinopyrimidine fungicide, to obtain the fungicidal combination.

In a preferred embodiment, the process for preparation of the fungicidal combination comprises:

adding and mixing ipflufenoquin and pyrimethanil, to obtain the fungicidal combination.

In a preferred embodiment, the process for preparation of the fungicidal combination comprises:

adding and mixing ipflufenoquin and cyprodinil, to obtain the fungicidal combination.

According to an embodiment, the process for preparation of the fungicidal composition comprises:

adding and mixing at least one quinoline fungicide, at least one anilinopyrimidine fungicide and at least one agrochemically acceptable excipient, to obtain the fungicidal composition.

In a preferred embodiment, the process for preparation of the fungicidal composition comprises:

adding and mixing ipflufenoquin, pyrimethanil and at least one agrochemically acceptable excipient, to obtain the fungicidal composition.

In a preferred embodiment, the process for preparation of the fungicidal composition comprises:

adding and mixing ipflufenoquin, cyprodinil and at least one agrochemically acceptable excipient, to obtain the fungicidal composition.

According to an embodiment, the process for preparation of a liquid formulation fungicidal composition comprises:

adding and mixing at least one quinoline fungicide, at least one anilinopyrimidine fungicide and at least one agrochemically acceptable excipient, to obtain the fungicidal composition.

In a preferred embodiment, the process for preparation of a liquid formulation fungicidal composition comprises:

adding and mixing ipflufenoquin, pyrimethanil and at least one agrochemically acceptable excipient, to obtain the fungicidal composition.

In a preferred embodiment, the process for preparation of a liquid formulation fungicidal composition comprises:

adding and mixing ipflufenoquin, cyprodinil and at least one agrochemically acceptable excipient, to obtain the fungicidal composition.

According to an embodiment, the process for preparation of a pre-mix fungicidal composition comprises:

adding and mixing at least one quinoline fungicide, at least one anilinopyrimidine fungicide and at least one agrochemically acceptable excipient, to obtain the fungicidal composition.

In a preferred embodiment, the process for preparation of a pre-mix fungicidal composition comprises:

adding and mixing ipflufenoquin, pyrimethanil and at least one agrochemically acceptable excipient, to obtain the fungicidal composition.

In a preferred embodiment, the process for preparation of a pre-mix fungicidal composition comprises:

adding and mixing ipflufenoquin, cyprodinil and at least one agrochemically acceptable excipient, to obtain the fungicidal composition.

According to an embodiment, the process for preparation of a suspension concentrate (SC) fungicidal composition comprises:

adding and mixing at least one quinoline fungicide, at least one anilinopyrimidine fungicide and at least one agrochemically acceptable excipient, to obtain the fungicidal composition.

In a preferred embodiment, the process for preparation of a suspension concentrate (SC) fungicidal composition comprises:

adding and mixing ipflufenoquin, pyrimethanil and at least one agrochemically acceptable excipient, to obtain the fungicidal composition.

According to an embodiment, the process for preparation of an oil in water emulsion (EW) fungicidal composition comprises:

adding and mixing at least one quinoline fungicide, at least one anilinopyrimidine fungicide and at least one agrochemically acceptable excipient, to obtain the fungicidal composition.

In a preferred embodiment, the process for preparation of an oil in water emulsion (EW) fungicidal composition comprises:

adding and mixing ipflufenoquin, cyprodinil and at least one agrochemically acceptable excipient, to obtain the fungicidal composition.

According to an embodiment, the present disclosure provides a method for controlling growth of fungal disease in a plant, the method comprising applying to the plant, or a locus, or a plant propagation material thereof, an effective amount of a fungicidal combination comprising at least one quinoline fungicide and at least one anilinopyrimidine fungicide.

According to an embodiment, the present disclosure provides a method for controlling fungal growth in a plant, the method comprising applying to the plant, or a locus, or a plant propagation material thereof, an effective amount of a fungicidal combination comprising at least one quinoline fungicide and at least one anilinopyrimidine fungicide.

In a preferred embodiment, the present disclosure provides a method for controlling growth of fungal disease in a plant, the method comprising applying to the plant, or a locus, or a plant propagation material thereof, an effective amount of a fungicidal combination comprising ipflufenoquin and pyrimethanil.

In a preferred embodiment, the present disclosure provides a method for controlling fungal growth in a plant, the method comprising applying to the plant, or a locus, or a plant propagation material thereof, an effective amount of a fungicidal combination comprising ipflufenoquin and pyrimethanil.

In a preferred embodiment, the present disclosure provides a method for controlling growth of fungal disease in a plant, the method comprising applying to the plant, or a locus, or a plant propagation material thereof, an effective amount of a fungicidal combination comprising ipflufenoquin and cyprodinil.

In a preferred embodiment, the present disclosure provides a method for controlling fungal growth in a plant, the method comprising applying to the plant, or a locus, or a plant propagation material thereof, an effective amount of a fungicidal combination comprising ipflufenoquin and cyprodinil.

According to an embodiment, the present disclosure provides a method for controlling growth of fungal disease in a plant, the method comprising applying to the plant, or a locus, or a plant propagation material thereof, an effective amount of a fungicidal composition comprising at least one quinoline fungicide, at least one anilinopyrimidine fungicide, and at least one agrochemically acceptable excipient.

According to an embodiment, the present disclosure provides a method for controlling fungal growth in a plant, the method comprising applying to the plant, or a locus, or a plant propagation material thereof, an effective amount of a fungicidal composition comprising at least one quinoline fungicide, at least one anilinopyrimidine fungicide, and at least one agrochemically acceptable excipient.

In a preferred embodiment, the present disclosure provides a method for controlling growth of fungal disease in a plant, the method comprising applying to the plant, or a locus, or a plant propagation material thereof, an effective amount of a fungicidal composition comprising ipflufenoquin, pyrimethanil, and at least one agrochemically acceptable excipient.

In a preferred embodiment, the present disclosure provides a method for controlling fungal growth in a plant, the method comprising applying to the plant, or a locus, or a plant propagation material thereof, an effective amount of a fungicidal composition comprising ipflufenoquin, pyrimethanil, and at least one agrochemically acceptable excipient.

In a preferred embodiment, the present disclosure provides a method for controlling growth of fungal disease in a plant, the method comprising applying to the plant, or a locus, or a plant propagation material thereof, an effective amount of a fungicidal composition comprising ipflufenoquin, cyprodinil, and at least one agrochemically acceptable excipient.

In a preferred embodiment, the present disclosure provides a method for controlling fungal growth in a plant, the method comprising applying to the plant, or a locus, or a plant propagation material thereof, an effective amount of a fungicidal composition comprising ipflufenoquin, cyprodinil, and at least one agrochemically acceptable excipient.

According to another embodiment, examples of trees and plants include apple, almond, grape, and stone fruit.

In a preferred embodiment, the stone fruit comprises peach.

In a preferred embodiment, apple trees (apple crop) are cultivated throughout the world, and their fruit is edible and widely consumed. Apple crops are affected by fungi such as, but not limited to, Venturia inaequalis, Podosphaera leucotricha, Diplocarpon mali, Botryosphaeria obtusa, Botryosphaeria dothidea, and Colletotrichum species.

In a preferred embodiment, almond trees (almond crops) are also widely cultivated throughout the world. Almond crops are affected by fungi such as, but not limited to, Monilia species, examples of which include Monilia laxa, Monilia fructigena and Monilia fructicola.

In another preferred embodiment, grapes are a commercially important crop in many countries of the world. The major producers of grapes are Italy, France, Spain, USA, Turkey, China, and Argentina. Pests affecting grape crops include, but are not limited to, Venturia inaequalis, Diplocarpon mali, Botryosphaeria obtusa, Podosphaera leucotricha, and Alternaria mali.

In another preferred embodiment, peach plants are grown in both the northern and southern hemispheres. The major pests of peach include, but are not limited to, Alternaria alternata, Monilinia fructicola, Monilinia laxa, Armillaria spp., and Cercospora circumscissa.

According to an embodiment, the present disclosure provides a method for controlling growth of fungal disease in a crop comprising apple, almond, or stone fruit, the method comprising applying to the crop, a locus, or a plant propagation material thereof, an effective amount of a fungicidal combination comprising:

(a) at least one quinoline fungicide; and

(b) at least one anilinopyrimidine fungicide.

In a preferred embodiment, the stone fruit crop is peach.

According to an embodiment, the present disclosure provides a method for controlling growth of fungal disease in a crop comprising apple, almond, or stone fruit, the method comprising applying to the crop, a locus, or a plant propagation material thereof, an effective amount of a fungicidal combination comprising:

(a) ipflufenoquin; and

(b) pyrimethanil.

According to an embodiment, the present disclosure provides a method for controlling growth of fungal disease in a crop comprising apple, almond, or stone fruit, the method comprising applying to the crop, a locus, or a plant propagation material thereof, an effective amount of a fungicidal combination comprising:

(a) ipflufenoquin; and

(b) cyprodinil.

According to an embodiment, the present disclosure provides a method for controlling growth of fungal disease in a crop comprising apple, almond, or stone fruit, the method comprising applying to the crop, a locus, or a plant propagation material thereof, an effective amount of a fungicidal composition comprising:

(a) at least one quinoline fungicide;

(b) at least one anilinopyrimidine fungicide; and

(c) at least one agrochemically acceptable excipient.

In a preferred embodiment, the stone fruit crop is peach.

According to an embodiment, the present disclosure provides a method for controlling growth of fungal disease in a crop comprising apple, almond, or stone fruit, the method comprising applying to the crop, a locus, or a plant propagation material thereof, an effective amount of a fungicidal composition comprising:

(a) ipflufenoquin;

(b) pyrimethanil; and

(c) at least one agrochemically acceptable excipient.

According to an embodiment, the present disclosure provides a method for controlling growth of fungal disease in a crop comprising apple, almond, or stone fruit, the method comprising applying to the crop, a locus, or a plant propagation material thereof, an effective amount of a fungicidal composition comprising:

(a) ipflufenoquin;

(b) cyprodinil; and

(c) at least one agrochemically acceptable excipient.

In the following embodiments, the g a.i./ha refers to the combination, that is the total of both actives.

In yet another embodiment, the present disclosure provides a method for controlling growth of fungal disease, the method comprising applying a fungicidal combination comprising at least one quinoline fungicide and at least one anilinopyrimidine fungicide, wherein the fungicidal combination is applied in a range from about 10 g a.i./ha to about 500 g a.i./ha.

In a preferred embodiment, the present disclosure provides a method for controlling growth of fungal disease, the method comprising applying a fungicidal combination comprising at least one quinoline fungicide and at least one anilinopyrimidine fungicide, wherein the fungicidal combination is applied in a range from about 50 g a.i./ha to about 450 g a.i./ha.

In a preferred embodiment, the present disclosure provides a method for controlling growth of fungal disease, the method comprising applying a fungicidal combination comprising at least one quinoline fungicide and at least one anilinopyrimidine fungicide, wherein the fungicidal combination is applied in a range from about 100 g a.i./ha to about 400 g a.i./ha.

In a preferred embodiment, the present disclosure provides a method for controlling growth of fungal disease, the method comprising applying a fungicidal combination comprising at least one quinoline fungicide and at least one anilinopyrimidine fungicide, wherein the fungicidal combination is applied in a range from about 250 g a.i./ha to about 360 g a.i./ha.

In a preferred embodiment, the present disclosure provides a method for controlling growth of fungal disease, the method comprising applying a fungicidal combination comprising at least one quinoline fungicide and at least one anilinopyrimidine fungicide, wherein the fungicidal combination is applied in a range from about 0.25 kg a.i./ha to about 0.36 kg a.i./ha.

According to an embodiment of the present disclosure, the various components of the fungicidal combination can be used individually, or partially or completely mixed with one at least one another to prepare the combination according to the disclosure. It is also possible for them to be packaged and used further as composition such as a kit of parts.

The disclosure also provides a kit comprising fungicidal combination for the controlling fungal growth or growth of fungal disease and instructions for use. The instructions for use typically comprise instructions for the application of the fungicidal combination to the plant, to a locus, or to a plant propagation material thereof.

According to an embodiment, the kit of parts comprises:

a) at least one quinoline fungicide;

b) at least one anilinopyrimidine fungicide;

c) at least one agrochemically acceptable excipient;

and optionally further comprises:

d) instructions for use.

In one embodiment of the disclosure, the kit may include one or more components that may be used to prepare the fungicidal combination, e.g., kits may include active ingredients and/or agrochemically acceptable excipients. One or more of the components may already be combined together or pre-formulated. In those embodiments where more than two components are provided in a kit, the components may already be combined together and as such are packaged in a single container such as a vial, bottle, can, pouch, bag or canister. In other embodiments, two or more components of a kit may be packaged separately, i.e., not pre-formulated. As such, kits may include one or more separate containers such as vials, cans, bottles, pouches, bags or canisters, each container containing a separate component for fungicidal combination.

In both forms, a component of the kit may be applied separately from or together with the further components or as a component of a combination according to the disclosure for preparing the fungicidal combination according to the disclosure.

In another embodiment, the fungicidal combination described above is stable, over time and at various temperatures.

All the features described herein may be combined with any of the above aspects, in any combination.

According to an embodiment, it has been particularly found that certain weight ratios of the quinoline fungicides to the anilinopyrimidine fungicides are able to provide synergistic activity. Therefore, a further aspect of the disclosure are compositions in which the quinoline fungicides and the anilinopyrimidine fungicides are present in amounts producing a synergistic effect. This synergistic activity is apparent from the fact that the fungicidal activity of the composition comprising both the quinoline fungicides and the anilinopyrimidine fungicides is greater than the sum of the individual fungicidal activities of the quinoline fungicides and the anilinopyrimidine fungicides. Fungicidal activity of the combinations can be seen from the examples which follow. While the individual active compounds show less activity with regard to fungicidal activity, certain combinations have a fungicidal activity which exceeds the expected efficacy. These combinations or compositions as described above may be used in a synergistically effective amount. It can be seen from the examples herein below that the fungicidal action of the combinations according to the disclosure exceeds the calculated value, that is to say that the fungicidal combinations have a synergistic effect in controlling growth of fungal disease in plants.

In yet another embodiment, whether a combination is synergistic or is not synergistic is determined by comparison of observed efficacy of the fungicidal combination to that of expected efficacy of the fungicidal combination. This is calculated by Colby's Equation.

In Colby's equation given below, E is the expected efficacy of the combination of the quinoline fungicides and the anilinopyrimidine fungicide, X is the observed efficacy of the quinoline fungicides, and Y is the observed efficacy of the anilinopyrimidine fungicide. Observed efficacy values (i.e., X and Y) are the percentage (%) of disease control (e.g., percent reduction in fungal disease severity) for the quinoline fungicides and the anilinopyrimidine fungicide used alone. If the observed efficacy of the combination of quinoline fungicides and the anilinopyrimidine fungicide is greater than its expected efficacy, then the combination is determined to be synergistic. If the observed efficacy is equal to or less than the expected efficacy, then the combination is determined to be non-synergistic.

Colby's equation:E=X+Y−XY/100

In an embodiment, the present disclosure provides a synergistic agrochemical combination.

Accordingly in an embodiment, the present disclosure provides a synergistic fungicidal combination.

Accordingly in an embodiment, the present disclosure provides synergistic fungicidal combinations.

Accordingly in an embodiment, the present disclosure provides a synergistic fungicidal combination comprising:

(a) at least one quinoline fungicide; and

(b) at least one anilinopyrimidine fungicide.

Accordingly in an embodiment, the present disclosure provides a synergistic fungicidal combination comprising:

(a) at least one quinoline fungicide; and

(b) at least one anilinopyrimidine fungicide wherein the quinoline fungicide and the anilinopyrimidine fungicide are present in a ratio of 1:6.7.

Accordingly in an embodiment, the present disclosure provides a synergistic fungicidal combination comprising:

(a) at least one quinoline fungicide; and

(b) at least one anilinopyrimidine fungicide wherein the quinoline fungicide and the anilinopyrimidine fungicide are present in a ratio of 1:4.9.

Accordingly in an embodiment, the present disclosure provides a synergistic fungicidal combination comprising:

(a) at least one quinoline fungicide; and

(b) at least one anilinopyrimidine fungicide wherein the quinoline fungicide and the anilinopyrimidine fungicide are present in a synergistic ratio of 1:6.7.

Accordingly in an embodiment, the present disclosure provides a synergistic fungicidal combination comprising:

(a) at least one quinoline fungicide; and

(b) at least one anilinopyrimidine fungicide wherein the quinoline fungicide and the anilinopyrimidine fungicide are present in a synergistic ratio of 1:4.9.

Accordingly in an embodiment, the present disclosure provides a synergistic fungicidal combination comprising:

(a) ipfufenoquin; and

(b) at least one anilinopyrimidine fungicide.

Accordingly in an embodiment, the present disclosure provides a synergistic fungicidal combination comprising:

(a) at least one quinoline fungicide; and

(b) pyrimethanil.

Accordingly in an embodiment, the present disclosure provides a synergistic fungicidal combination comprising:

(a) at least one quinoline fungicide; and

(b) cyprodinil.

Accordingly in an embodiment, the present disclosure provides a synergistic fungicidal combination comprising:

(a) ipfufenoquin; and

(b) pyrimethanil.

Accordingly in an embodiment, the present disclosure provides a synergistic fungicidal combination comprising:

(a) ipfufenoquin; and

(b) cyprodinil.

Accordingly in an embodiment, the present disclosure provides a synergistic fungicidal combination comprising:

(a) ipfufenoquin; and

(b) pyrimethanil;

wherein ipflufenoquin and pyrimethanil are present in a ratio of 1:6.7.

Accordingly in an embodiment, the present disclosure provides a synergistic fungicidal combination comprising:

(a) ipfufenoquin; and

(b) pyrimethanil;

wherein ipflufenoquin and pyrimethanil are present in a synergistic ratio of 1:6.7.

Accordingly in an embodiment, the present disclosure provides a synergistic fungicidal combination comprising:

(a) ipfufenoquin; and

(b) cyprodinil;

wherein ipflufenoquin and cyprodinil are present in a ratio of 1:4.9.

Accordingly in an embodiment, the present disclosure provides a synergistic fungicidal combination comprising:

(a) ipfufenoquin; and

(b) cyprodinil;

wherein ipflufenoquin and cyprodinil are present in a synergistic ratio of 1:4.9.

Accordingly in an embodiment, the present disclosure provides a synergistic fungicidal composition comprising:

(a) at least one quinoline fungicide; and

(b) at least one anilinopyrimidine fungicide; and

(c) at least one agrochemically acceptable excipient.

Accordingly in an embodiment, the present disclosure provides a synergistic fungicidal composition comprising:

(a) ipflufenoquin; and

(b) at least one anilinopyrimidine fungicide; and

(c) at least one agrochemically acceptable excipient.

Accordingly in an embodiment, the present disclosure provides a synergistic fungicidal composition comprising:

(a) at least one quinoline fungicide; and

(b) pyrimethanil; and

(c) at least one agrochemically acceptable excipient.

Accordingly in an embodiment, the present disclosure provides a synergistic fungicidal composition comprising:

(a) at least one quinoline fungicide; and

(b) cyprodinil; and

(c) at least one agrochemically acceptable excipient.

Accordingly in an embodiment, the present disclosure provides a synergistic fungicidal composition comprising:

(a) ipflufenoquin; and

(b) pyrimethanil; and

(c) at least one agrochemically acceptable excipient.

Accordingly in an embodiment, the present disclosure provides a synergistic fungicidal composition comprising:

(a) ipflufenoquin; and

(b) cyprodinil; and

(c) at least one agrochemically acceptable excipient.

Accordingly in an embodiment, the present disclosure provides use of a synergistic fungicidal combination for controlling growth of fungal disease in a plant, the combination comprising:

(a) at least one quinoline fungicide; and

(b) at least one anilinopyrimidine fungicide.

Accordingly in an embodiment, the present disclosure provides a process for preparation of a synergistic fungicidal combination comprising:

adding and mixing at least one quinoline fungicide and at least one anilinopyrimidine fungicide to form a mixture, to obtain a fungicidal combination.

Accordingly in an embodiment, the present disclosure provides a method for controlling growth of fungal disease in a plant, the method comprising applying to a plant, or a locus, or a plant propagation material thereof, an effective amount of a synergistic fungicidal combination comprising:

(a) at least one quinoline fungicide; and

(b) at least one anilinopyrimidine fungicide.

Accordingly in an embodiment, the present disclosure provides use of a synergistic fungicidal composition for controlling growth of fungal disease in a plant, the composition comprising:

(a) at least one quinoline fungicide;

(b) at least one anilinopyrimidine fungicide; and

(c) at least one agrochemically acceptable excipient.

Accordingly in an embodiment, the present disclosure provides a process for preparation of a synergistic fungicidal composition comprising:

adding and mixing at least one quinoline fungicide, at least one anilinopyrimidine fungicide and at least one agrochemically acceptable excipient to form a mixture, to obtain a fungicidal composition.

Accordingly in an embodiment, the present disclosure provides a method for controlling growth of fungal disease in a plant, the method comprising applying to a plant, or a locus, or a plant propagation material thereof, an effective amount of a synergistic fungicidal composition comprising:

(a) at least one quinoline fungicide; and

(b) at least one anilinopyrimidine fungicide; and

(c) at least one agrochemically acceptable excipient.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention is not limited to the particular embodiment disclosed as the best mode contemplated for carrying out this invention, but that the invention will include all embodiments falling within the scope of the appended claims. Any combination of the above-described elements in all possible variations thereof is encompassed by the invention unless otherwise indicated herein or otherwise clearly contradicted by context. These and other advantages of the disclosure may become more apparent from the examples set forth herein below. These examples are provided merely as illustrations of the disclosure and are not intended to be construed as a limitation thereof.

### EXAMPLES

### Example 1: Preparation of Ipflufenoquin 78 G/L+Pyrimethanil 532 G/L SC

| Ingredients | Quantity (g/l) | (%) w/w |
|---|---|---|
| Ipflufenoquin | 78.65 | 7.15 |
| Pyrimethanil | 532.62 | 48.42 |
| Sodium salt of naphthalene sulfonate | 10.01 | 0.91 |
| condensate | | |
| Acrylic copolymer solution | 50.05 | 4.55 |
| Polyalkylene oxide block copolymer | 4.95 | 0.45 |
| Water | Q.S. | Q.S. |
| Total | 1000 | 100 |

### Process

Water, 2-bromo-2-nitro-1,3-propanediol, xanthan gum, propylene glycol, acrylic copolymer solution, sodium salt of naphthalene sulfonate condensate and polyalkylene oxide block copolymer were added to a batch tank and mixed well using a mixer. To the mixture, ipflufenoquin and pyrimethanil were added and mixed until well dispersed to achieve the desired suspension concentrate.

### Example 2: Preparation of Ipflufenoquin 69 G/L+Cyprodinil 348 G/L Ew

| Ingredients | Quantity (g/l) | (%) w/w |
|---|---|---|
| Ipflufenoquin | 69.70 | 6.69 |
| Cyprodinil | 348.40 | 34.04 |
| Tristyrylphenol ethoxylate | 12.44 | 1.19 |
| Linear calcium alkylbenzene sulfonate | 82.56 | 7.90 |
| Castor oil ethoxylate | 61.66 | 5.90 |
| Water | Q.S. | Q.S. |
| Total | 1000 | 100 |

### Process

Water, 1,2-propanediol, 2-butoxyethanol, cyclohexanone, castor oil ethoxylate, linear calcium alkylbenzene sulfonate and tristyrylphenol ethoxylate were added to a batch tank and mixed well using a mixer. To the mixture, ipflufenoquin and cyprodinil were added and mixed until well dispersed to achieve the desired oil in water emulsion (EW).

### Example 3

Experiments were carried out to evaluate the bio-efficacy of the fungicidal combination of ipflufenoquin and pyrimethanil against a fungal infection affecting an apple crop. Table 1 provides a summary of the target crop (apple), the combination of actives that was tested (Ipflufenoquin+Pyrimethanil), and the range of the application rate(s) of the combination.

TABLE 1
Application rates of Ipflufenoquin and Pyrimethanil

| | | | Application | Application |
|---|---|---|---|---|
| | | | Rate Range | Rate Range |
| | | | for the | for the |
| | Active | Ratio of | Combination | Combination |
| Crop | Ingredients | Active(s) | (lbs a.i./a) | (kg a.i./ha) |
| Apple | Ipflufenoquin + | 1:6.7 | 0.22 to 0.31 | 0.25 to 0.36 |
| | Pyrimethanil | | | |

lbs ai/a = pounds active agent per acre
kg ai/ha = kilograms total active agent per hectare

Table 2 provides a summary of the treatments tested for their ability to prevent apple scab caused by the fungus Venturia inaequalis in an apple crop. The combination was applied three different times. The application timings were: (1) tight cluster-pink, (2) bloom, and (3) 1^{st} cover spray. For treatment number 2, the individual actives were mixed with each other.

TABLE 2
FUNGICIDAL COMBINATION OF IPFLUFENOQUIN AND
PYRIMETHANIL

| Ex- | | | | | | |
|---|---|---|---|---|---|---|
| am- | | Ratio | | fl oz/a | | Total |
| ple | | of | Formula- | or | lbs | lbs |
| No. | Treatment | Actives | tion | oz wt/a | a.i./a | a.i./a |
| 1. | Untreated | NA | NA | NA | NA | NA |
| 2. | Ipflufenoquin + | 1:6.7 | Tank Mix | 3.14 + 7 | 0.041 + | 0.31 |
| | Pyrimethanil | | | | 0.273 | |

fl oz/a = fluid ounces per acre
oz wt/a = ounce weight per acre
lbs a.i./a = pound active ingredient per acre

Table 3 provides a summary of the percent (%) scab severity (caused by Venturia inaequalis) on leaves, observed after treatments were completed on the leaves. The % Scab Severity was calculated on the basis of total number of leaves affected.

TABLE 3
PERCENTAGE SCAB SEVERITY ON LEAVES

| | | | | | % Reduction |
|---|---|---|---|---|---|
| Example | | Ratio of | fl | % | in scab |
| No. | Treatment | Actives | oz/a | Severity | severity |
| 1. | Untreated | NA | NA | 64 | — |
| 2. | Ipflufenoquin + | 1:6.7 | 3.14 + 7 | 0 | 100 |
| | Pyrimethanil | | | | |

### Example 4

Experiments were carried out to evaluate the efficacy of the fungicidal combination of ipflufenoquin and pyrimethanil against brown rot (Monilinia fructicola) affecting peach crop, as disclosed in Table 4.

TABLE 4
IPFLUFENOQUIN AND PYRIMETHANIL
AGAINST BROWN ROT

| | | | % Disease | |
|---|---|---|---|---|
| Example | | Rate | incidence on | % Severity on |
| No. | Treatment | (fl oz/a) | Fruit | Fruit |
| 1. | Untreated | NA | 96 | 63.8 |
| 2. | Ipflufenoquin | 4 | 42.5 | 20.3 |
| 3. | Pyrimethanil | 8.9 | 19.5 | 15.5 |
| 4. | Ipflufenoquin + | 4 + 8.9 | 3.5 | 2 |
| | Pyrimethanil | | | |

Experiments were carried out to evaluate the efficacy of the fungicidal combination of ipflufenoquin and pyrimethanil against Coryneum blight (Wilsonomyces spp.) affecting peach crop, as disclosed in Table 5.

TABLE 5
IPFLUFENOQUIN AND PYRIMETHANIL
AGAINST CORYNEUM BLIGHT

| | | | % Disease | |
|---|---|---|---|---|
| Example | | Rate | incidence on | % Severity on |
| No. | Treatment | (fl oz/a) | Fruit | Fruit |
| 1. | Untreated | NA | 100 | 69.9 |
| 2. | Ipflufenoquin | 4 | 36.8 | 6.9 |
| 3. | Pyrimethanil | 8.9 | 65.8 | 42.8 |
| 4. | Ipflufenoquin + | 4 + 8.9 | 10 | 2.9 |
| | Pyrimethanil | | | |

### Example 5

Experiments were carried out to evaluate the efficacy of the fungicidal combination of ipflufenoquin and pyrimethanil (both tank mix fungicidal combination and pre-mix formulation as disclosed in Example 1) against scab (Cladosporium sp.) affecting pecan (i.e., nuts), as disclosed in Table 6.

TABLE 6
IPFLUFENOQUIN AND PYRIMETHANIL AGAINST SCAB

| Example | | Rate | % Severity on |
|---|---|---|---|
| No. | Treatment | (fl oz/a) | Nuts |
| 1. | Untreated | NA | 33.8 |
| 2. | Ipflufenoquin | 4 | 8.4 |
| 3. | Pyrimethanil | 8.9 | 19.2 |
| 4. | Ipflufenoquin + Pyrimethanil | 4 + 8.9 | 0.1 |
| | (Tank mix) | | |
| 5. | Ipflufenoquin + Pyrimethanil | 10 | 0.0 |
| | (Pre-mix) | | |
| 6. | Ipflufenoquin | 5 | 6.7 |
| 7. | Pyrimethanil | 11.1 | 15.7 |
| 8. | Ipflufenoquin + Pyrimethanil | 5 + 11.1 | 0.1 |
| | (Tank mix) | | |
| 9. | Ipflufenoquin + Pyrimethanil | 12.5 | 0.0 |
| | (Pre-mix) | | |

### Example 6

Experiments were carried out to determine if ipflufenoquin+pyrimethanil at a 1:6.7 ratio shows higher level of control as compared to 1:2.5 and 1:5 ratios. The study was carried out on apple scab (Venturia inaequalis). The results have been disclosed in Table 7.

Treatment A: 0.1 Ipflufenoquin: 0.25 Pyrimethanil μg/ml a.i. (Ratio 1:2.5)

Treatment B: 0.1 Ipflufenoquin: 0.5 Pyrimethanil μg/ml a.i. (Ratio 1:5)

Treatment C: 0.1 Ipflufenoquin: 0.667 Pyrimethanil μg/ml a.i. (Ratio 1:6.7)

TABLE 7
IPFLUFENOQUIN AND PYRIMETHANIL
AT VARIOUS RATIOS

| | Untreated | Treatment A | Treatment B | Treatment C |
|---|---|---|---|---|
| | (% growth of | (% growth of | (% growth of | (% growth of |
| Sr. No. | disease) | disease) | disease) | disease) |
| 1 | 100 | 58.0 | 10.2 | 4.5 |
| 2 | 100 | 71.7 | 47.5 | 6.8 |
| 3 | 100 | 48.4 | 14.5 | 6.5 |
| 4 | 100 | 70.7 | 6.7 | 2.7 |
| 5 | 100 | 76.4 | 10.9 | 5.5 |

It was observed that ipflufenoquin+pyrimethanil at 1:6.7 ratio showed better control of the % growth of disease. As disclosed in the treatment, lower % growth of disease indicates higher level of % control. This was observed at the 1:6.7 ratio.

### Example 7

Experiment were carried out to confirm the synergism of the combination ipflufenoquin and pyrimethanil. When concentrations of the two fungicides were both lower than their minimum effective concentration (MEC) a significant growth reduction was indicated. Ten of the 14 isolates tested showed evidence of synergism for the combination, as disclosed in Table 8.

Isolates: Single spore isolates (from Conidia). These isolates came from trees that had not been exposed to fungicides.

Assessment: Results were examined using tTest (paired) to detect the minimum level of concentration that significantly reduced growth. Relative growth was determined by dividing the average treatment diameter by the diameter of the control (0.0).

TABLE 8
IPFLUFENOQUIN AND PYRIMETHANIL AT VARIOUS RATIOS

| Number | MECs of | Treatment Concentration of | Significant Growth |
|---|---|---|---|
| of | Ipflufenoquin:Pyrimethanil | Ipflufenoquin:Pyrimethanil | Reduction^{a} |
| Isolates | (μg/ml a.i.) | (μg/ml a.i.) | Significant/Total |
| 5 | 0.001:0.5 | 0.0005:0.2 | 3 |
| 1 | 0.01:0.5 | 0.005:0.2 | 0 |
| 2 | 0.005:0.5 | 0.001: 0.2 | 2 |
| 1 | 0.1:0.5 | 0.05:0.2 | 1 |
| 1 | 0.005:0.005 | 0.001:0.001 | 1 |
| 3 | 5.0:1.0 | 0.25:0.25 | 3 |
| 1 | 1.0:1.0 | 0.25:0.25 | 0 |

^{a}Paired tTest comparing control and treatment

1. A fungicidal combination comprising:
(a) at least one quinoline fungicide; and
(b) at least one anilinopyrimidine fungicide.

2. The combination as claimed in claim 1, wherein the quinoline fungicide comprises ethoxyquin, halacrinate, 8-hydroxyquinoline sulfate, ipflufenoquin, quinacetol, a salt of quinacetol, quinofumelin, quinoxyfen, proquinazid, tebufloquin, or a combination thereof.

3. The combination as claimed in claim 2, wherein the quinoline fungicide is ipflufenoquin.

4. The combination as claimed in claim 1, wherein the anilinopyrimidine fungicide comprises pyrimethanil, cyprodinil, mepanipyrim, or a combination thereof.

5. The combination as claimed in claim 4, wherein the anilinopyrimidine fungicide is pyrimethanil.

6. The combination as claimed in claim 4, wherein the anilinopyrimidine fungicide is cyprodinil.

7. The combination as claimed in claim 1, wherein the combination comprises ipflufenoquin and pyrimethanil.

8. The combination as claimed in claim 1, wherein the combination comprises ipflufenoquin and cyprodinil.

9. The combination as claimed in claim 1, wherein the combination comprises quinoline fungicide in a concentration range from about 10 to about 100 g/L.

10. The combination as claimed in claim 1, wherein the combination comprises anilinopyrimidine fungicide in a concentration range from about 250 to about 550 g/L.

11. The combination as claimed in claim 1, wherein a weight ratio of the quinoline fungicide to the anilinopyrimidine fungicide ranges from about 50:1 to about 1:50.

12. A fungicidal composition comprising the combination of claim 1 and
(c) at least one agrochemically acceptable excipient.

13. The composition as claimed in claim 12, wherein the quinoline fungicide comprises ethoxyquin, halacrinate, 8-hydroxyquinoline sulfate, ipflufenoquin, quinacetol and salts of quinacetol, for example quinacetol sulfate, quinofumelin, quinoxyfen, proquinazid, tebufloquin, or a combination thereof.

14. The composition as claimed in claim 13, wherein the quinoline fungicide is ipflufenoquin.

15. The composition as claimed in claim 12, wherein the anilinopyrimidine fungicide comprises pyrimethanil, cyprodinil, mepanipyrim, or a combination thereof.

16. The composition as claimed in claim 15, wherein the anilinopyrimidine fungicide is pyrimethanil.

17. The composition as claimed in claim 15, wherein the anilinopyrimidine fungicide is cyprodinil.

18. The composition as claimed in claim 12, wherein the agrochemically acceptable excipient comprises dispersant/dispersing agents, carriers, emulsifiers, colorants, thickeners, binders, antifreeze agents, antifoaming agents, antioxidants, solvents, preservatives, diluents, auxiliary agents, or a combination thereof.

19. The composition as claimed in claim 12, wherein the fungicidal composition comprises from about 1% w/w to about 30% w/w of the quinoline fungicide of total weight of the composition.

20. The composition as claimed in claim 12, wherein the fungicidal composition comprises from about 10% w/w to about 50% w/w of the anilinopyrimidine fungicide of total weight of the composition.

21. The composition as claimed in claim 12, wherein the fungicidal composition comprises from about 1% w/w to about 30% w/w of the agrochemically acceptable excipient of total weight of the composition.

22. The composition as claimed in claim 12, wherein the composition is present in a form of a liquid formulation.

23. The composition as claimed in claim 22, wherein the composition is present in a form of a tank mix or a pre-formulated (pre-mix)/ready-mix formulation.

24. A method for controlling growth of fungal disease in a plant, the method comprising
applying to the plant, a locus of the plant, or a plant propagation material, an effective amount of the fungicidal combination comprising at least one quinoline fungicide and at least one anilinopyrimidine fungicide.

25. A method for controlling growth of fungal disease in a plant, the method comprising:
applying to the plant, a locus of the plant, or a plant propagation material, an effective amount of the fungicidal composition comprising at least one quinoline fungicide, at least one anilinopyrimidine fungicide and at least one agrochemically acceptable excipient.

26. The method as claimed in claim 25, wherein the method comprises applying the fungicidal combination in a range from about 250 g a.i./ha to about 360 g a.i./ha.
